(19) United States
(12) Patent Application Publication
(10) Pub. No.: US 2014/0142981 A1
(43) Pub. Date: May 22, 2014

(54) Analytics and Data Mining in Cloud Following Upload of Analyte Data via GSM or CDM

(71) Applicants: Mani Gopal, Hillsborough, CA (US); Gary A. Hayter, Oakland, CA (US); Timothy C. Dunn, San Francisco, CA (US); Daniel M. Bernstein, El Granada, CA (US); Eric Davis, Castro Valley, CA (US); Brittany K. Bradrick, San Francisco, CA (US); Todd Winkler, Cameron Park, CA (US)

(72) Inventors: Mani Gopal, Hillsborough, CA (US); Gary A. Hayter, Oakland, CA (US); Timothy C. Dunn, San Francisco, CA (US); Daniel M. Bernstein, El Granada, CA (US); Eric Davis, Castro Valley, CA (US); Brittany K. Bradrick, San Francisco, CA (US); Todd Winkler, Cameron Park, CA (US)

(73) Assignee: Abbott Diabetes Care Inc., Alameda, CA (US)

(21) Appl. No.: 13/984,819

(22) PCT Filed: Dec. 21, 2011
(86) PCT No.: PCT/US11/66615

§ 371 Date: Nov. 25, 2013

Related U.S. Application Data
(60) Provisional application No. 61/442,097, filed on Feb. 11, 2011.

(51) Int. Cl. G06F 19/00; H04L 29/08

(52) U.S. Cl. CPC G06F 19/345; H04L 67/02; G06F 19/322
USPC 705/3; 709/219; 705/2

(57) ABSTRACT

Presented herein is a web-based software application that clinically analyzes multiple sources of diabetes patient data against codified care plan guidelines. The software application creates risk-based stratifications of a patient population, initiates rule-based notifications, allocates care provider resources, guides role-based workflow, manages patient communications, and provides therapy recommendations.

### CROSS-REFERENCE TO RELATED APPLICATIONS

Pursuant to 35 U.S.C. §119(e), this application claims priority to U.S. Provisional Application No. 61/442,097 filed on Feb. 11, 2011, the disclosure of which is herein incorporated by reference in its entirety.

This application is related to U.S. Provisional Application No. 61/442,085 filed on Feb. 11, 2011; U.S. Provisional Application No. 61/486,117 filed on May 13, 2011; U.S. Provisional Patent Application No. 61/442,063 filed on Feb. 11, 2011; U.S. Provisional Application No. 61/442,092 filed on Feb. 11, 2011; U.S. Provisional Application No. 61/485,840 filed on May 13, 2011; and U.S. Provisional Application No. 61/442,093 filed on Feb. 11, 2011, the disclosures of which are all incorporated herein by reference in their entirety and for all purposes.

### BACKGROUND OF THE INVENTION

1. The Field of the Invention

The present invention relates to diabetes management systems. More specifically, the present invention relates to a web-based diabetes management/monitoring software application.

2. Background

Healthcare organizations and care providers, such as disease management companies, have a responsibility of providing continuous care to their patient populations. To effectively carry out this responsibility, these care organizations must appropriately allocate their resources (i.e., triage) across the criticality of needs within their patient populations. Such triage activity relies upon patients to notify their care providers about their status, and the care providers to initiate an appropriate workflow in response.

Current diabetes management systems have several disadvantages. First, diabetes patients are often unaware when their health status departs from pre-defined boundaries of their normal care plan. These departures may go unnoticed, or slowly growing and worsening, especially if the departures are episodic. Second, in severe cases of departure from normal status, diabetes patients may become incapacitated and unable to contact their care providers. Third, care providers who are contacted by patients must rely upon self-reported symptoms to triage criticality. These self-reported symptoms often disguise the true causality or severity, which may result in a dangerous under/over estimation of criticality. Further, the procedures that care providers initiate in response to patient status are commonly guided by standards of care. The workflows that underlie those procedures, however, are typically not well-defined or appropriately monitored. As such, care provider resources are used efficiently. Finally, care providers base their therapy decisions upon the patient data at hand. In many clinical settings, the process of accessing patient self-monitoring data is inconsistent and results in inefficient workflows that undermine the care provider's efforts to collect the data. In cases where these obstacles are overcome, the acquired self-monitoring data typically lacks appropriate analysis and does not insightfully guide therapy decisions. As a result, clinical therapy decisions are primarily guided by point-in-time lab test results that do not depict important health patterns, which fully analyzed self-monitoring data can reveal. Without a full depiction of the patient's status, prescribed therapies are typically under-informed and lack appropriate levels of effectiveness.

### BRIEF SUMMARY

Presented herein is a web-based system (e.g., software application) that clinically analyzes multiple sources of diabetes patient data against codified care plan guidelines. The software application creates risk-based stratifications of a patient population, initiates rule-based notifications, allocates care provider resources, guides role-based workflow, manages patient communications, and provides therapy recommendations.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use the present invention.

FIG. 1 provides a schematic illustration of one aspect of the present invention.

FIG. 2 provides a schematic illustration of another aspect of the present invention.

### DETAILED DESCRIPTION OF THE INVENTION

Before the embodiments of the present disclosure are described, it is to be understood that this invention is not limited to particular embodiments described, as such may, of course, vary. It is also to be understood that the terminology used herein is for the purpose of describing particular embodiments only, and is not intended to be limiting, since the scope of the embodiments of the invention will be limited only by the appended claims.

In one embodiment, there is provided a diabetes management system that clinically analyzes multiple sources of diabetes patient data against codified care plan guidelines. The system may be in the form of a web-based software application. The system may create risk-based stratifications of a patient population, initiate rule-based notifications, allocate care provider resources, guide role-based workflows, provide therapy recommendations, and/or real-time/retrospective clinical analysis.

In one embodiment, diabetes patient data is uploaded to a web-based software application. The software application then compares the data against care plan guidelines established by a health care provider, payor, care provider organization, medical association, government standard board, or any combination thereof. The software application can then use clinical algorithms to assign a status value to the patient. The status value may represent triage criteria, such as status criticality, regimen adherence, data recency, and/or usual care schedule (including lab results and completeness metrics). The patient's assigned status value(s) are correlated with the rest of the patient population under care to produce sortable stratifications for the care managers. The care managers then use these stratifications to allocate health provider resources according to their care roles.

In one embodiment, health providers receive their assigned responsibilities and use the system to guide their workflows in the performance of their assigned responsibilities. As tasks are completed, and procedural results are logged, the system continually processes newly entered data against clinical guidelines to adapt the workflows and notify hand-offs between care provider roles.

In another embodiment, the system gathered data is used to provide therapy recommendations. For example, the system may include a therapy recommendation engine. The therapy recommendation engine may be configured to enforce adherence to established clinical guidelines and cost efficiencies. These configuration mechanisms are represented by: 1) a list of medications where payors select/deselect medications depending on their willingness to pay for the medication (the deselected medications would not be included in the possible recommended treatment paths); 2) a list of allowable treatment guidelines, which includes glucose measurement methods, glucose measurement frequency, clinical visit frequency, and/or specialist referrals; and 3) diabetes metric thresholds such as mean glucose, HbA1C, and hypoglycemia frequency, which can be configured to conditionally approve certain medications and treatments.

In yet another embodiment, the system provides patients with guidance that supports their adherence to prescribed regimens. The prescribed regimen may be translated into a task and schedule list that may be electronically published to a patient's local device. The patient's local device may be a blood glucose meter, a mobile phone, local kiosk, or a home health monitoring hub. System software on the patient's device guides the patient's adherence to the published regimen, and provides escalated notifications when their adherence level drops. According to rules configured within the system, these notifications may be routed to any stakeholder using the diabetes management system; including family members, care providers, payors, etc.

The system may further communicate, in parallel, to a variety of patient endpoints. This communication may be electronic messaging or voice telephony. These endpoints may be, for example: multiple patient devices that operate locally-resident components of the system software, such as blood glucose meters, mobile phones, or home health monitoring hubs; email addresses; telephone numbers; etc.

Various protocols may be provided to implementing the diabetes management system. For example, the patient's data may be automatically uploaded whenever a new data set has been produced, and a data connection is present. Alternatively, the patient's data may be automatically uploaded according to synchronization rules held in the web-based application, and pushed to the patient device through data communication channels. In another example, the patient's data may be uploaded by a patient-initiated action, prompted through a notification alert generated by the web-based application rules pushed to the patient device through the data communication channels.

In one embodiment, the diabetes management system includes patient communications means, which includes automated notifications that are managed between multiple devices registered to a single patient. Such patient communication means are governed by a content management system component, which appropriately adapts the communication for the device class, device capability, and patient set preferences. in the case of data conflicts due to connection persistence, or lack thereof, trickle synch methods compare the conflicts to establish a master record and modify each slave record according to synchronization rules such as overwrite, append, or ignore. The data analysis results produced by the web-based application may be published in the care providers electronic health record system.

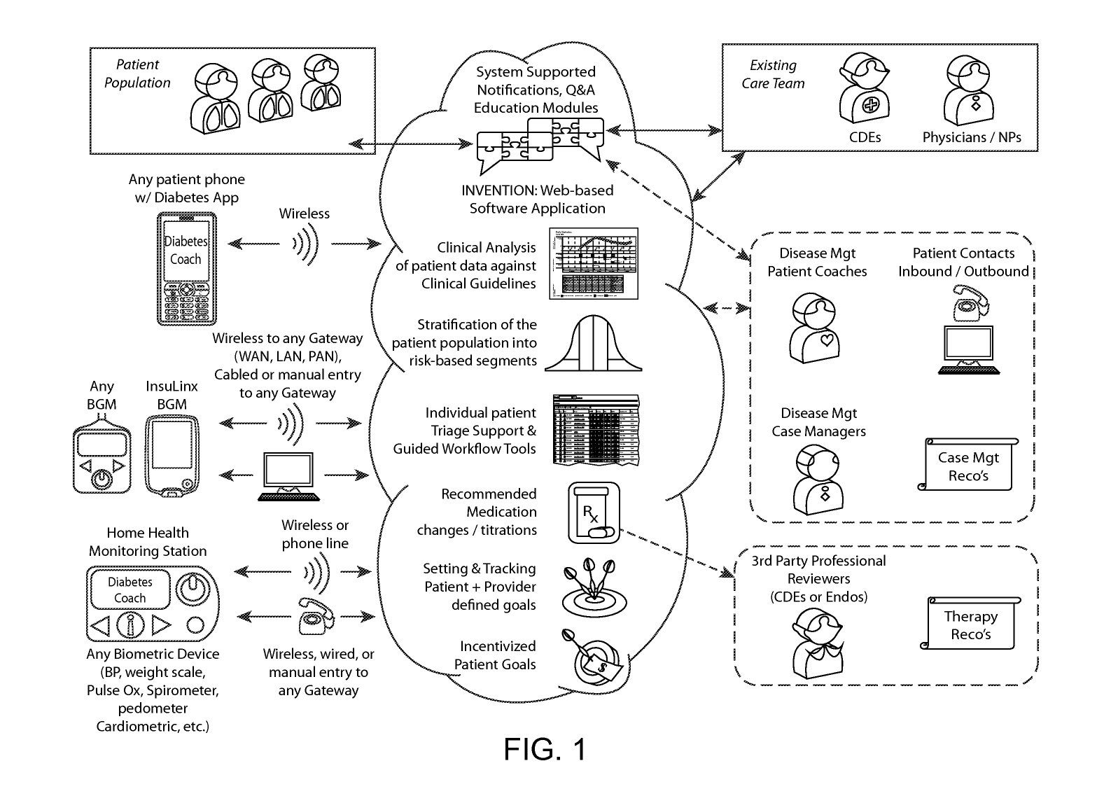

FIG. 1 provides a schematic illustration of one aspect of the present invention. As shown in FIG. 1, a patient population (left side of schematic) communicates data to a cloud, network, or centralized database. The communication between the patient population and the cloud, network, or centralized database may be through one or more patient devices such as mobile phones with diabetes application software; wired or wireless BG meters; home health monitoring systems; or any other biometric device configured to communicate with the cloud, network, or centralized database.

The cloud, network, or centralized database includes a system support and notification engine; a clinical analysis engine; a patient stratification engine; an individual patient triage engine; a recommendation engine; a setting & tracking engine; and/or a patient incentive engine. Each of such engines provides information, and may be managed by, one or more HCPs (right side of schematic) for the patient population. As such, FIG. 1 presents a robust diabetes management system.

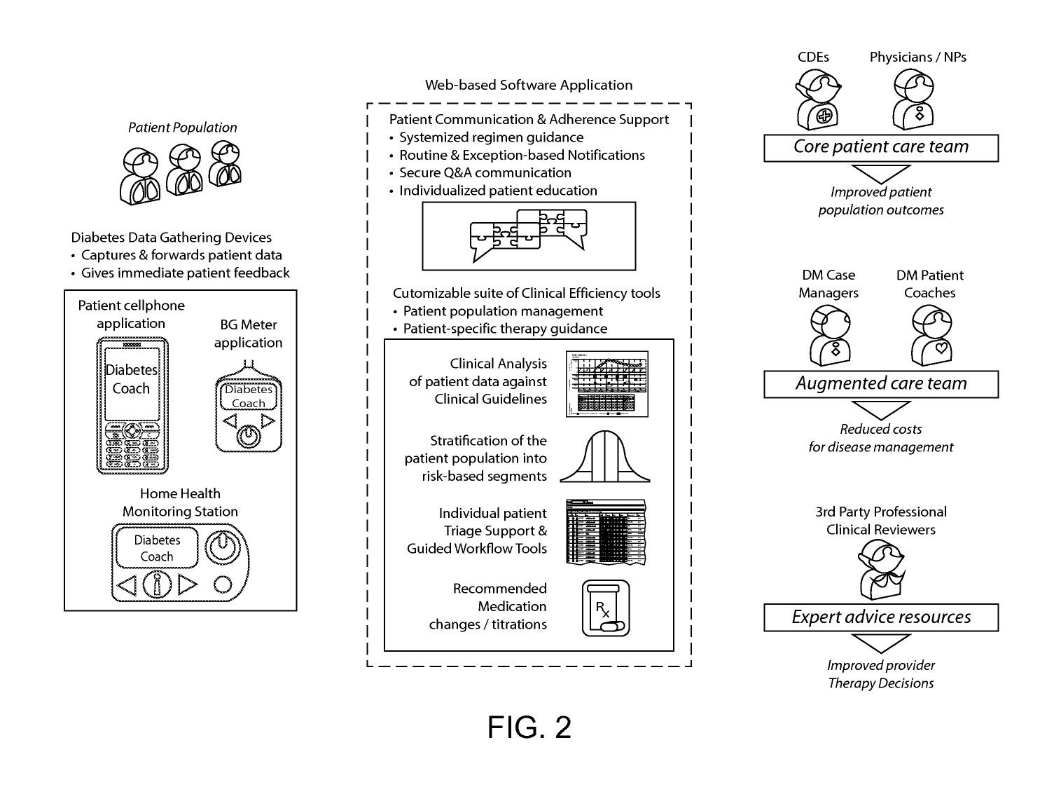

FIG. 2 provides a schematic illustration of another aspect of the present invention. FIG. 2 shows the three vertical levels of the present invention. The first vertical level is the patient population with individual diabetes monitoring, data collection, and data communication devices. The patient population sends data to the second and third vertical levels, and receive analysis/instructions from the second and third vertical levels, through their individual devices. The second vertical level is a web-based software application including one or more of the above-listed software engines. The third vertical level is the HCP network, which includes: a core patient care team; an augmented care team; and/or expert advice resources. The flow of information can be managed accordingly such that the most efficient use of the HCPs' time can be used. In other words, only patients with the highest degree of need, would receive the highest level of HCP attention.

The system presented herein provides several advantages over the current practices. First, automatically collected patient data, from several sources, is combined and clinically analyzed to produce an accurate assessment of patient condition. This patient condition is analyzed against codified care plan guidelines to automatically recognize exceptions and grade their criticality. Patient status is accurately monitored without reliance on patient recognition of symptoms and self-reporting. Second, in severe cases of patient incapacitation, the automated process of collecting and analyzing patient data may still occur, and the appropriate notifications automatically sent to care providers. Third, when care providers receive exception-based notifications, the system provides them with a data-supported clinical analysis of patient condition, which enables clinical judgments superior to those made with only patient self-reported symptoms. Further, the system contains codified workflows that guide appropriately triaged clinical responses to each patient's status. These workflows allocate the proper care provider roles, guide their clinical procedures, track their completion status, modify the workflows in accordance with procedural findings, and coordinate the handoffs between different care provider roles. As a result, health provider resources are more efficiently allocated and utilized across the collective needs of the patient population. Finally, the automatically collected and analyzed patient data is readily accessible to care providers through a consistent and efficient workflow. This data analysis includes a comparison of alternative treatment regimens against evidence-based clinical guidelines to suggest the most appropriate therapy choices. As a result, care providers' prescribed therapies are much more informed and effective.

In one embodiment, the systems and methods presented herein are used to provide personalized trials for patients with individualized treatments, medications, or regimens. Real-time or short-term data can be provided to the HCP in a feedback loop for the HCP to determine if/how the trial is working for the patient. The systems may also include algorithms for determining how the patient is doing within the personalized trial.

The types diabetes medications disclosed herein include insulin and other diabetes medications such as alpha-glucosidase inhibitors, amylin analogs, SGLT2 inhibitors, and the like.

In one embodiment, the systems and methods presented herein are resident in EMR/PHR systems. The systems and methods can be context sensitive and self-populate within the EMR/PHR system.

### CONCLUSION

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

In the description of the invention herein, it will be understood that a word appearing in the singular encompasses its plural counterpart, and a word appearing in the plural encompasses its singular counterpart, unless implicitly or explicitly understood or stated otherwise. Merely by way of example, reference to “an” or “the” “analyte” encompasses a single analyte, as well as a combination and/or mixture of two or more different analytes, reference to “a” or “the” “concentration value” encompasses a single concentration value, as well as two or more concentration values, and the like, unless implicitly or explicitly understood or stated otherwise. Further, it will be understood that for any given component described herein, any of the possible candidates or alternatives listed for that component, may generally be used individually or in combination with one another, unless implicitly or explicitly understood or stated otherwise. Additionally, it will be understood that any list of such candidates or alternatives, is merely illustrative, not limiting, unless implicitly or explicitly understood or stated otherwise.

Various terms are described to facilitate an understanding of the invention. It will be understood that a corresponding description of these various terms applies to corresponding linguistic or grammatical variations or forms of these various terms. It will also be understood that the invention is not limited to the terminology used herein, or the descriptions thereof, for the description of particular embodiments. Merely by way of example, the invention is not limited to particular analytes, bodily or tissue fluids, blood or capillary blood, or sensor constructs or usages, unless implicitly or explicitly understood or stated otherwise, as such may vary.

The publications discussed herein are provided solely for their disclosure prior to the filing date of the application. Nothing herein is to be construed as an admission that the embodiments of the invention are not entitled to antedate such publication by virtue of prior invention. Further, the dates of publication provided may be different from the actual publication dates which may need to be independently confirmed.

The detailed description of the figures refers to the accompanying drawings that illustrate an exemplary embodiment of an analyte measurement system. Other embodiments are possible. Modifications may be made to the embodiment described herein without departing from the spirit and scope of the present invention. Therefore, the following detailed description is not meant to be limiting.

Certain embodiments presented herein relate to electrical interfaces in measurement devices. Measurement devices often have electrical interfaces that allow them to electrically connect with another device or apparatus and perform an analysis of an analyte. A device that measures blood glucose levels, for example, includes electrical interfaces that allow the device to measure the blood glucose level from a small blood sample.

1. A diabetes management system, comprising:
a plurality of analyte measurement devices distributed over a patient population;
a centralized server having a web-based software application, wherein the software application includes instructions executable by a processing device, wherein, when executed, the instructions cause the processor to perform one or more functions selected from the group consisting of: patient support notifications, clinical analysis of patient data, stratification of patient population in risk-based segments, individual patient triage, medication recommendations, setting and tracking of patient or provider defined goals, titration, change of medication amount, change of medication timing, change of medication type, and incentive patient goals; and
a network receiving information from the centralized server and managing the functions performed by the web-based software application on the centralized server.

2. The diabetes management system of claim 1, wherein the plurality of analyte measurement devices communicate with the centralized server via a wired or wireless network.

3. The diabetes management system of claim 1, wherein the plurality of analyte measurement devices communicate with the centralized server via a cellular network.

4. The diabetes management system of claim 1, wherein the plurality of analyte measurement devices include: a cellular phone with a diabetes software application, a blood glucose meter, a home health monitoring system, or other biometric device.

5. The diabetes management system of claim 4, wherein the other biometric device is selected from the group consisting of: a blood pressure measurement device, a weight scale, a pulse oximeter, a spirometer, a pedometer, and a cardiometric measurement device.

6. A diabetes management system for clinically analyzing multiple sources of diabetes patient data against codified care plan guidelines, comprising:
a web-based software application having instructions executable by a processing device, wherein, when executed, the instructions cause the processor to
create risk-based stratifications of a patient population,
initiate rule-based notifications,
allocate care provider resources,
guide role-based workflows, and
provide therapy recommendations.

7. A diabetes management system for clinically analyzing multiple sources of diabetes patient data against codified care plan guidelines, comprising:
a web-based software application having instructions executable by a processing device, wherein, when executed, the instructions cause the processor to
uploaded patient data to the web-based software application,
compare the data against care plan guidelines established by a health care provider, payor, care provider organization, medical association, government standard board, or any combination thereof,
use clinical algorithms to assign a status value to the patient, wherein the status value represents triage criteria selected from the group consisting of: status criticality, regimen adherence, data recency, and usual care schedule, and
correlate the patient's assigned status value(s) the rest of the patient population under care to produce sortable stratifications for the care managers.

8. The diabetes management system of claim 7, wherein the care managers use the stratifications to allocate health provider resources according to their care roles.

9. The diabetes management system of claim 7, wherein the care managers receive assigned responsibilities and use the web-based software application to guide their workflows in the performance of their assigned responsibilities.

10. The diabetes management system of claim 7, wherein as tasks are completed, and procedural results are logged, the web-based software application continually processes newly entered data against clinical guidelines to adapt the workflows and notify hand-offs between care manager roles.

11. The diabetes management system of claim 7, wherein the web-based software application further includes instructions executable by a processing device, wherein, when executed, the instructions cause the processor to provide therapy recommendations.

12. The diabetes management system of claim 11, wherein the therapy recommendations enforce adherence to established clinical guidelines and cost efficiencies.

13. The diabetes management system of claim 12, wherein the web-based software application further includes instructions that provide:
a list of medications to select/deselect medications,
a list of treatment guidelines, which includes glucose measurement methods, glucose measurement frequency, clinical visit frequency, and specialist referrals, and
diabetes metric thresholds such as mean glucose, HbA1C, and hypoglycemia frequency.

14. A diabetes management system for clinically analyzing multiple sources of diabetes patient data against codified care plan guidelines, comprising:
a web-based software application having instructions executable by a processing device, wherein, when executed, the instructions cause the processor to provide patients with guidance that supports their adherence to prescribed regimens, wherein the prescribed regimen may be translated into a task and schedule list that may be electronically published to a patient's local device.

15. The diabetes management system of claim 14, wherein the patient's local device is selected from the group consisting of: a blood glucose meter, a mobile phone, and a home health monitoring hub.

16. The diabetes management system of claim 15, wherein software on the patient's device guides the patient's adherence to the prescribed regimen, and wherein software on the patient's devices provides escalated notifications when the patient's adherence to the prescribed regimen drops, or lack of interaction.

17. The diabetes management system of claim 16, wherein the notifications are routed to a family member, a care provider, or a payor.
